(19) United States
(12) Patent Application Publication
(10) Pub. No.: US 2004/0232345 A1
(43) Pub. Date: Nov. 25, 2004

(54) Continuous monitoring radon detector

(76) Inventors: Pillalamarri Jagam, Guelph (CA); John J. Simpson, Gorssel (NL)

Correspondence Address: Kathryn A. Piffat, Ph.D., Intellectual Property Practice Group of, EDWARDS & ANGELL, LLP, P.O. Box 9169, Boston, MA, 02209, US

(21) Appl. No.: 10/401,593

(22) Filed: Mar. 31, 2003

(51) Int. Cl. G01T 1/24

(52) U.S. Cl. 250/370.02

(57) ABSTRACT

A device for the continuous monitoring in situ of radon concentration in ambient air, and the simultaneous measurement of working level (WL) values of the radon daughters in ambient air. The device comprises an electrical field formed of two hemispherical walls facing each other with a gap therebetween allowing ambient air to diffuse through. The area between the walls is considered a “sensitive volume”. A positively-charged photodiode is disposed in communication with the sensitive volume for the detection of alpha emissions from radon or radon progeny electrically isolated within said electrical field.

### FIELD OF THE INVENTION

The present invention relates generally to a radon detector. More particularly, the present invention relates to a device for the continuous, in situ monitoring of radon daughter concentrations in ambient air.

### BACKGROUND OF THE INVENTION

Radon (Rn) is a noble gas in the same chemical group as He, Ne, Ar, Kr, Xe, but is radioactively unstable. It occurs in the natural radioactive decay chains of uranium and thorium. There are three naturally occurring isotopes. ²²²Rn occurs in the decay chain of ²³⁸U and is known as radon. ²²⁰Rn occurs in the decay chain of ²³²Th and is called thoron. ²¹⁹Rn occurs in the decay chain of ²³⁵U and is called actinon. They are able to diffuse out of soil and all materials where they are formed. High energy alphas occur in the decay of the radon isotopes as well as in the decay of the progeny which are heavy metals like polonium, lead, bismuth and thallium. The isotopes collect in air and, when we breathe them in, the lung tissue is subject to the bombardment of high energy alpha particle radiation from these various isotopes. This exposure can damage normally healthy cells and cause cancer in the lung. Exposure to radiation from radon and its progeny has been reported to be the second biggest cause of lung cancer. A radon concentration of 4 pCi/L (148 Bq/m³) is of particular interest for residential monitoring applications and in underground locations in industrial settings for monitoring compliance with the regulations of various government agencies. Therefore, radon mitigation was made mandatory above the limits specified by regulatory agencies in many countries around the world.

Prior art detectors of radon and radon progeny concentrations in air have several disadvantages. Generally, in situ detection devices that continuously monitor ambient air for radon isotopes are not commonly available. Current devices typically rely on sampling pumps to infuse a quantity of air to be analyzed. Also, the pumps tend to add unnecessary bulkiness to the detector unit. This restricts portability of the unit and adds an additional burden of extra power requirements.

Very few prior art radon detectors have a sufficiently short response time to measure values below the mandatory limits. The working level values in ambient air are typically not determined continuously and simultaneously in real time (i.e., in situ) and assumptions about equilibrium factors must be made in order to calibrate the instrument.

Radon daughters are identified by energy spectrometry of the characteristic alpha articles they emit. Current radon detectors generally do not detect the three isotopes of radon. They typically use positively-charged mesh-configured and/or pressed porous metal filters to prevent the entry of radon daughters into the sensitive volume. The alpha particles which are emitted in the decay process are a form of ionizing radiation that can be hazardous to humans. A greater danger is presented by radon daughters which originate as metal ions and become affixed to airborne dust particles. During normal respiration, persons exposed to radon concentrations inhale dust with radon daughters affixed or “plated” thereto. Despite the importance of detecting radon daughters, many devices in the prior art fail to detect them.

Radon progeny are positively charged in the decay of radon as well as in the subsequent decays. Therefore, they can be collected on a suitable surface, which is electrically isolated from the container defining the sensitive volume to be sampled by the application of a negative electric field across a sampling volume. This method is called the electrostatic chamber (ESC) method. Radon detectors using the ESC method have been described in by Wang et al. (1999), Kiko (2001) and Hopke (1989).

U.S. Pat. No. 5,053,624, issued to Kronenberg, discloses a radon detector having a wire screen defining a cylindrical enclosure, and a medial wire screen positioned within the cylindrical enclosure.

The radon detector disclosed by Diamondis (U.S. Pat. No. 5,489,780) possesses a reverse biased photodiode and allows air to diffuse into the sensitive volume defined by the metal enclosure. However, it possesses a porous metal filter that prevents the entry of radon daughter products into the sensitive volume and thus cannot easily be calibrated.

Although methods for the detection of charged particles in air are well established in the prior art, the compartments used for establishing a sensitive volume of air to be analyzed and generating an electric field are generally not optimized. Because of this, a confident assessment of sensitivity is typically not realized. Prior art radon detectors, particularly those few that detect radon as well as its progeny, tend to be expensive. In addition to the electrode and battery components, the cost of producing a vessel to establish a shaped electric field are high. Often, the vessels must be specially fabricated to accommodate larger volumes of collected air.

U.S. Pat. No. 5,029,248 issued to Miyake discloses a radon detector consisting of a funnel-shaped enclosure with a semispherical surface at one end, and an electrode seated at the other end. The hemispherical/funnel shape of the enclosure concentrates alpha particles onto the central part of the electrode. However, it is difficult to establish an ideal sensitive volume of air to be analyzed in this device.

U.S. Pat. No. 5,550,381, issued to Bolton et al., and U.S. Pat. No. 4,871,914, issued to Simon et al. disclose similar devices that allow air to diffuse into the sensitive volume.

Howard et al. (1990) disclose a sensitive, closed-volume, cylindrical radon detector system that detects ²¹⁸Po decay. However, this system has not been optimized for efficient collection of radon daughters.

Alpha particles emitted from radon and its progeny are typically detected with a photodiode or similar device. U.S. Pat. No. 4,891,514, issued to Gjerdrum et al., exploits the alpha particle susceptibility of dynamic random access memories (DRAM). U.S. Pat. No. 4,859,854, issued to Kershner et al., discloses a radon detector that counts alpha particles from radon and radon daughters attracted to a centre rod.

It is, therefore, desirable to provide an efficient detector for the continuous monitoring of radon and its progeny. It is also desirable that the radon detector has a cost-effective shaped electric field to maximize the collection efficiency of the radon progeny.

### SUMMARY OF THE INVENTION

It is an object of the present invention to obviate or mitigate at least one disadvantage of previous radon detectors. Advantageously, certain embodiments of the invention are inexpensive to produce, and allow for the continuous monitoring of the isotopes of ambient air radon. A further advantage is that embodiments of the invention may be used as multipurpose continuously-monitoring in situ radon detector, to allow for real-time detection of radon and/or radon daughters. Because samples need not be sent away for analysis, reaction to high levels of radon can be undertaken relatively quickly as desired.

According to the invention there is provided a device for detection of radon or radon daughters in ambient air comprising: a) an electrical field comprising two hemispherical walls facing each other, with a gap therebetween through which ambient air diffuses, said walls forming a sensitive volume; and b) a positively-charged photodiode in communication with said sensitive volume for the detection of alpha emissions from radon or radon progeny electrically isolated within said electrical field.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an overall schematic illustration of a radon detection system according to an embodiment of the invention.

FIG. 2 provides a schematic exploded view of a radon detector according to an embodiment of the present invention.

FIG. 3 provides a perspective view of the diode mount attached to the radon detector.

FIG. 4 shows a schematic of an exemplary battery box which provides various voltages to the radon detector.

FIG. 5 shows a typical data output from a radon detector of the invention. Counts of ²¹⁸Po and ²¹⁴Po are plotted against run time in 3 hour steps.

### DETAILED DESCRIPTION

Generally, the present invention provides a device for the detection of radon and progeny in ambient air. Specifically, the invention is a multimode device concept for the continuous monitoring of radon and radon daughter concentration, and the simultaneous measurement of working level (WL) values of the radon daughters in ambient air, in situ.

Embodiments of the present invention provide a multimode device for the continuous in situ monitoring of radon concentrations while simultaneously measuring other parameters, such as the working level (WL) values of the radon daughters (or progeny), in ambient air. The device can also detect trace contaminants in air which would normally hinder accurate detection of radon.

The invention relates to a device for detection of radon or radon daughters in ambient air comprising: a) an electrical field comprising two hemispherical walls facing each other, with a gap therebetween through which ambient air diffuses, the walls forming a sensitive volume; and b) a positively-charged photodiode in communication with the sensitive volume for the detection of alpha emissions from radon or radon progeny electrically isolated within said electrical field.

The hemispherical walls may, for example comprise food preparation bowls or any convenient hemispherical or near hemispherically shaped material. As an alternative, the walls may comprise hemispherical steel round-bottomed deep fryers.

The gap between the walls may be from 1 to 6 mm between the two hemispherical walls. For example, the gap may be about 1.5 mm. For larger gaps than about 6 mm, it is possible to add an optional light shielding means, which would be positioned near to, but not closing, the gap so as to partially exclude light from the sensitive volume.

The sensitive volume may be any desirable volume, depending on the desired application. For example, the volume may be from 1 L to 400 L. Certain food preparation bowl sizes are readily available that would allow for sensitive volumes of approximately 11 L, 60 L, and 208 L.

The hemispherical walls may alternatively comprise aluminum tubing supporting an aluminized polyester film on all sides. The tubing may have any acceptable diameter, for example, approximately 0.5 inch. In this case, larger volumes may be achieved, such as up to about 1000 L.

The photodiode may be a positive-intrinsic-negative (PiN) diode, and may, for example, be operated in a reverse bias mode.

The device is capable of detecting, among others, alpha emissions emitted from daughters generated from the decay of radon (²²²Rn) or thoron (²²⁰Rn). Such daughters as ²¹⁸Po, ²¹⁴Bi, or ²¹⁴Po emitting energetic alpha particle radiation at 6003 keV, 6020 keV, and 7687 keV respectively, are included in these. Daughters are generated from decay of thoron and are ²¹⁶Po or ²¹²Po, emitting energetic alpha particle radiation at 6778 keV and 8785 keV, respectively.

Thus, the invention provides a method for computing concentration of radon in ambient air comprising evaluating relative ratio of radon daughters ²¹⁸Po and ²¹⁴Po in the sensitive volume of a the device.

A system is also provided for detection of radon or radon daughter concentrations in ambient air comprising: a) the device of claim 1; a) a battery box in communication with said positively charged photodiode; b) signal conditioning means for receiving and manipulating a signal from said positively charged photodiode; and d) a computer to receive a manipulated signal from the signal condition means to display a radon or radon daughter concentration.

The present invention comprises a near symmetrical electrical field which allows ambient air to diffuse within it, creating a sensitive volume of air. The invention provides a nearly spherical electrical field to maximize the collection efficiency of the radon progeny directly on to the surface of a photodiode.

A prototype for the radon detector of the instant invention was prepared using metal salad bowls, and thus the term SABRE™ Radon Detector has been used, attributable to the acronym SABRE (“salad bowl radon electrostatic chamber”). Metal salad bowls provide an appropriate hemispherical shape adequate for use in the invention. Such bowls (interchangeably referred to herein as food preparation bowls) are available in a wide variety of sizes from restaurant supply stores in volumes ranging from less than 0.2 litre to 30 litres or more, which are intended for use in a variety of cooking applications, including large scale food production.

The uniform edge of such food preparation bowls allows placement of two hemispherical bowls with edges facing each other, so as to form the two hemispherical walls defining the boundaries of the electrical field of the device. Advantageously, when such bowls are used, the cost of these starting materials is remarkably economical compared with, for example, prior art devices having specially engineered walls or chambers.

An advantage of this invention is to allow air to diffuse into the sensitive volume, as defined by the hemispherical walls (which in some embodiments may be food preparation bowls) thus removing the necessity of pumps and allowing the present invention to be portable. According to the invention, there is no need to open and close the sensitive volume for counting purposes.

A windowless photodiode operated in the reverse bias mode may be employed to detect and to provide a proportionate signal for the identification of the various alpha particle emitting isotopes of polonium and other progeny by energy spectrometry. The photodiode is connected to signal conditioning circuits/components and a computer.

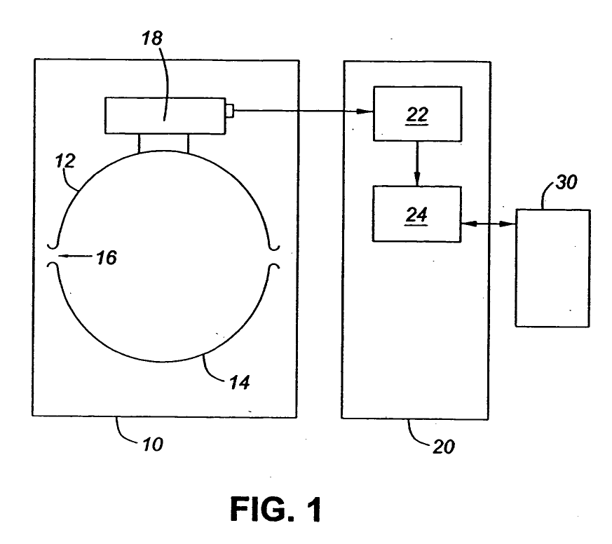

FIG. 1 is an overall schematic of a system including a radon detecting device according to an embodiment of the invention. The embodiment shown here may be referred to as a SABRE™ Radon Detector System. The system comprises consisting of the radon detector (10), having two hemispherical walls (12, 14) facing each other with a small gap (16) between them (shown here in section). These walls (12, 14) may be formed of food preparation bowls. The photodiode (18) is attached to a hemispherical wall (12) in a manner to allow reference grounding of the photodiode.

The system also includes a signal conditioning unit (20) which may include circuits and components to adequately treat the signal. This may, for example, include a preamplifier/amplifier (22), such as that made by Amptek U.S.A., which may optionally employ A203 or A206 chips. Within the conditioning unit, a Pocket MCA (24) may be employed, such as Model 8000A, made by Amptek U.S.A., or any other acceptable unit.

This embodiment of the system further comprises a computer (30), such as a laptop or other type of PC, for example a Toshiba Satellite, or equivalent. The computer receives information from the signal conditioning unit (20) and also interfaces with a user. The computer (30) can be used to controlling the detector and the circuits or components of the signal conditioning unit (20).

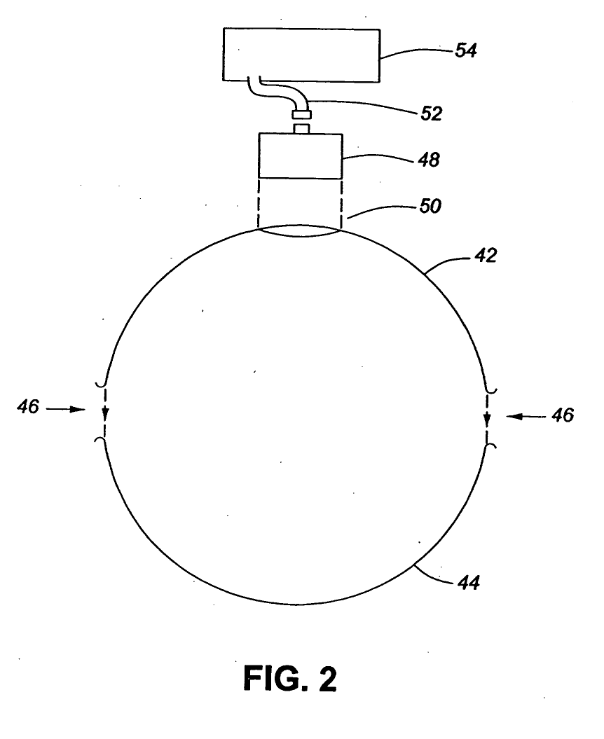

FIG. 2 illustrates an exploded view of the radon detector according to an embodiment of the invention. In this embodiment two hemispherical bowls (42, 44), here shown in cross-section, are disposed facing each other. The bowls may be moved toward each other to leave about a 1/16 (1.5 mm) inch gap (46) between them, so as to allow ambient air to circulate therethrough. A diode mount (48) is attached to the upper bowl (42), which has a hole therein (50) at a central portion. The diode mount is attached in this instance so that the hemispherical bowl (42) has ground protection or a reference ground. A cable connector (52) is used to connect a battery box (54) to the diode mount (48). The diode mount (48) contains a PiN diode. According to one embodiment, the bowls (42, 44) may be made of 12.5 inch diameter, 4¼ inch deep stainless steel bowls as a standard size SABRE™ radon detector, or may be 21.27 inch diameter, 8 inch deep steel bowls as a SABRE™ 100 radon detector. The detector may have pressure and humidity measuring probes designed for multimode operation as a portable unit (not shown).

In this embodiment of its assembled form, the two hemispherical bowls are clamped together to form a. The clamps used to achieve this may be of any desirable type, provided they do not fully impede the gap so that ambient air may continue to flow through. The near spherical shape formed by the bowls (42, 44) optimizes collection efficiency (i.e., minimizes or eliminates apparent “dead spots” in the sensitive volume).

In general, the gap (46) should be wide enough to allow the free movement of ambient air into the spherical shape, but should minimize the entry of light. The gap can be wider if light baffles are used. Ideally, the gap should be between about 1 mm and 6 mm, in the absence or presence of light baffles, but the width can be greater if light baffles are used. Optimum light baffling can be determined by one skilled in the art on the basis of readings obtained using the device with different widths of gaps.

In the embodiment of FIG. 2, the upper bowl has a 3″ diameter hole (50) for receiving the diode mount (48), and the diode mount (48) is connected to the battery box (54) via a cable (52).

The PiN diode used in this embodiment is a photodiode with a large, neutrally doped intrinsic region sandwiched between p-doped and n-doped semiconducting regions. PiN diodes offer good detector sensitivity to various forms of radiation and enhanced photocurrent measurement accuracy.

In an optional embodiment the PiN diode may be centrally located within the spherical arrangement (instead of at the edge of the arrangement as shown in FIG. 2), which would provide the diode with a central point equidistant from all locations within the sphere. This arrangement would require a reference ground, and non-metallic supports could be used to dispose the diode in a central portion of the sphere. This positioning would advantageously efficiently collect alpha emissions.

Because it operates in the reverse biased mode, the PiN diode in the instant invention offers sufficient energy discrimination to detect radon and thoron together with their daughters in ambient air.

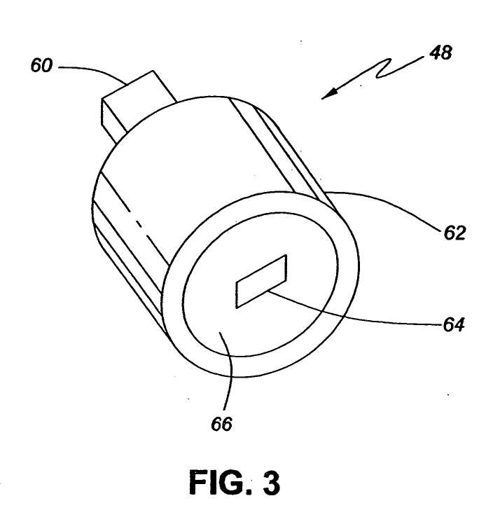

FIG. 3 provides a perspective view of the diode mount (48) of FIG. 2. In this particular embodiment, the diode mount may be about 3 to 4 inches in diameter, and 0.75 to 0.1 inches thick. Of course, other sizes may be used as desired, or as the detector is scaled up or down in size. The diode mount includes a cable connector (60), a mount insulator (62), a PiN diode (64) and a teflon insulator (66). In FIG. 3, the diode mount includes a steel ring 3.75″ in diameter×0.75″ thick with an inside diameter of 3″. The diode and the cable connector are mounted on a teflon insulator attached to the ring. PiN diodes are also commercially available devices that can be used for alpha particle detection and energy spectrometry. Typically, a 1″ square Hamamatsu® type S3204 PiN diode is used; however, any other PiN diode may be used for alpha particle detection and energy spectrometry.

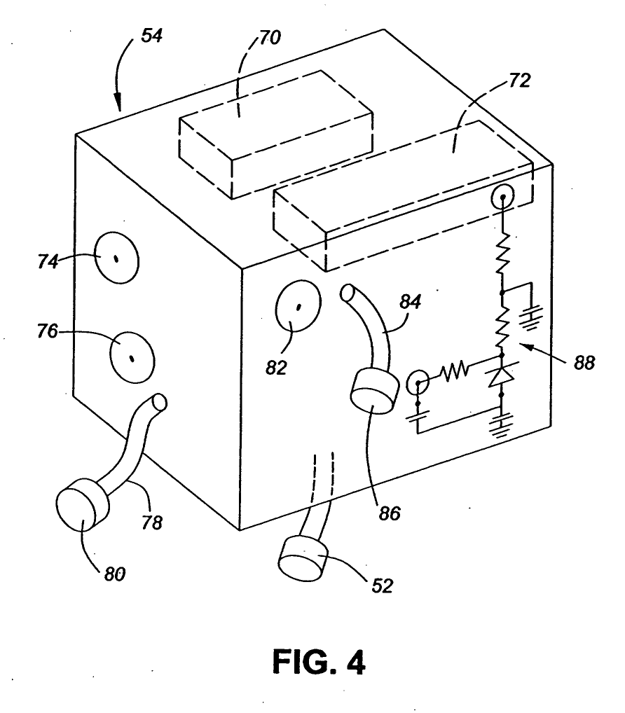

FIG. 4 shows a schematic of an exemplary battery box (54) which provides various voltages to the radon detector. In particular, the battery box reverse biases the PiN diode within the diode mount, and provides the signal connections required for deriving the electronic signal for energy spectrometry. Ideally, a reverse bias of 67.5 V is provided to the diode with a 67.5V battery (70). Furthermore, the box also supplies the negative bias for establishing an electrostatic field across the volume of air between the two bowls. Typically, a negative collection voltage of 510 V is applied to the collecting surface with a 510 V battery (72), which is electrically isolated with respect to the bowls or other hemispherical walls held at ground potential. This approach eliminates the danger of exposing the operators of the device to dangerous electrical shock. This voltage is adequate for achieving almost maximum collection efficiency for volumes less than 100 L. This voltage can be supplied by employing inexpensive commercially available photo flash batteries. Higher operating voltages for larger volumes are needed to realize the maximum achievable collection efficiency. However, it must be noted that these batteries and the voltages they provide are nominal values, and are chosen to optimize the operating conditions in each application, in order to achieve a specified detection sensitivity.

According to this embodiment, the Battery box (54) also has a signal OUT port (74); a signal IN port (76) for 67.5V “IN”; a cable to bias circuit (78); a connector to 67.5 V (80), a 510 V “IN” esc bias port (82); a cable connector (52) to connect the battery box to the diode mount; a cable from the battery (84); a connector to 510 V “IN” (86); and a schematic of the diode electrical (88) is illustrated on the box. In this particular case, the box has the dimensions of 19 cm×12 cm×8 cm, but of course, other dimensions may be used as desired.

Ambient air to be monitored for radon (including thoron) is allowed to enter the bowls by diffusion. No sampling pumps and collection filters are used to collect this volume of air. This volume is called the sensitive volume of the detector. Application of an electrostatic field between the bowls produces radon daughters that emit alpha particles. The alpha particles are captured by the PiN diode while it is operated under reverse bias conditions. The energy spectrometry of the characteristic alpha particles are used to identify the daughters. In addition, the working level value for thoron progeny can also be determined simultaneously.

The sensitive volume of the radon detector is chosen based on the response time required for a measurement of the radon concentration in air with a given precision. A radon concentration of 4 pCi/L (148 Bq/m³) is of particular interest for residential monitoring applications and in underground locations in industrial settings for monitoring compliance with the regulations of various government agencies. For typical portable monitors, a volume of 11.5 L is sufficient to obtain a response time of 1 h to determine a concentration of ²²²Rn of 0.1 pCi/L (3.7 Bq/m³) with a precision of 15% at one sigma counting statistics, and with a precision of 3% to determine a concentration of 4 pCi/L. Simultaneously, working level (WL) values of 0.0005 are readily determined. This value is based on matching the sampling volume to the concentration of radon (²²²Rn) and radon daughters (²¹⁸Po, ²¹⁴Bi and ²¹⁴Po) to achieve the sensitivity and precision in the required monitoring period. Another isotope of radon (thoron, i.e, ²²⁰Rn) is also detected and identified simultaneously with radon in real time with the choice of an appropriate sensitive volume.

Radon (²²²Rn) in air produces the daughters ²¹⁸Po, ²¹⁴Bi, and ²¹⁴Po which emit energetic alpha particle radiation at 6003 keV, 6020 keV, and 7687 keV respectively. Thoron (²²⁰Rn) in air produces the daughters ²¹⁶Po and ²¹²Po (via ²¹²Pb) which emit energetic alpha particle radiation at 6778 keV and 8785 keV, respectively. Using the relative ratio of the two radon daughters ²¹⁸Po and ²¹⁴Po, the counting efficiency is determined on-line to compute the absolute concentration of radon in ambient air. Unlike in other methods, no other equilibrium factors between the parent radon and the daughters are required to report the radon concentration.

Embodiments of the present invention allow a more sensitive and precise reading of radon than prior art radon detectors. Whereas current detectors detect 0.1 pCi/L/hour with a 10% variance, the SABRE™ radon detector (as described above) been yields a variance of only 3%. Because of a high collection efficiency, embodiments of the invention can detect lower amounts of signal than other detectors.

In one embodiment, the radon detector is portable, where the components for energy spectrometry including the laptop computer are calibrated. Software is used to present the data from the continuous monitoring of radon in air, automatically on the Internet using a client/server application. Remote data collection and control software can used for setting up and operating the radon detector system in remote locations, such as underground.

The radon detector may have a sensitive volume bounded by a right circular cylindrical shape (hemispherical in section), for example with a height is equal to the diameter, or with a cube shape or other geometric shapes with straight walls in order to maximize the collection efficiency in volumes greater than 100 L.

### EXAMPLE 1

The radon detector comprises two stainless steel bowls clamped together with a gap of approximately 1/16″ between them, for the collection of a sensitive volume of 11 L. The bowls are 12.5″ in diameter and 4.25″ deep. The upper bowl has a 3″ diameter hole to attach the diode mount. The battery box is attached on top to the diode mount after connecting the diode cable. A measurement precision of 7.5% at one sigma was achieved in one hour.

### EXAMPLE 2

A radon detector was assembled from two steel-round-bottomed deep fryers to create a sensitive volume of 60 L. The deep fryers were 21.75″ in diameter and 8″ deep, operated with the same diode mount as in Example 1. A radon concentration of 0.1 pCi/L (3.7 Bq/m³) was detected in three hour measurements giving a 12% precision at one sigma.

### EXAMPLE 3

A radon detector was assembled in the shape of an aluminum cube to create a sensitive volume of 208 L. This detector was operated with operated with the same diode mount as in Example 1.

### EXAMPLE 4

A radon detector was assembled from aluminum tubing to create a cubic frame having a sensitive volume of 1000 L. The tubing had a diameter of 0.5″ and supported an aluminized polyester film on all sides. The diode mount was centrally attached to the bottom of the cube with the battery box below it. Extremely low levels of radon were detected (concentration in the order of 0.05 pCi/L (mBq/m³) of air). A variable high voltage unit capable of supplying voltages up to 5000 V was used to establish the electrostatic field across the sensitive volume of the monitor.

### EXAMPLE 5

An electrostatic chamber (ESC) method was chosen and optimized for continuous monitoring of radon and thoron in air at the Sudbury Neutrino Observatory (SNO) in Sudbury, Canada. A SABRE™ radon detection system based on the ESC design was developed with a sensitive volume of 11 L. The SABRE™ radon detection system was operated in both a sealed mode and an open mode. The sealed mode used a sample of air from the test location while the open mode was used for continuous monitoring of radon in room air by allowing continuous exchange of air between the active volume (or sensitive volume) and the test location.

Radioactive equilibrium in room air was established in the sealed mode. More than 98% of radioactive equilibrium between the parent isotope ²²²Rn (half-life 3.8235 d) and first daughter ²¹⁸Po (half-life 3.05 min) was achieved approximately 18 minutes after collecting the sample. The counts under the alpha peak at MeV corresponding to ²¹⁸Po after the first 18 minutes were then directly proportional to the concentration of radon in room air.

²¹⁴Po may also be used for the detection of radon concentrations. A minimum of four hours were required for more than 98% of equilibrium before starting to record a spectrum. The number of counts in the ²¹⁸Po and ²¹⁴Po peaks in the spectra recorded in this mode are nearly identical indicating that the counting efficiency was the same with either peak for radon concentration determination.

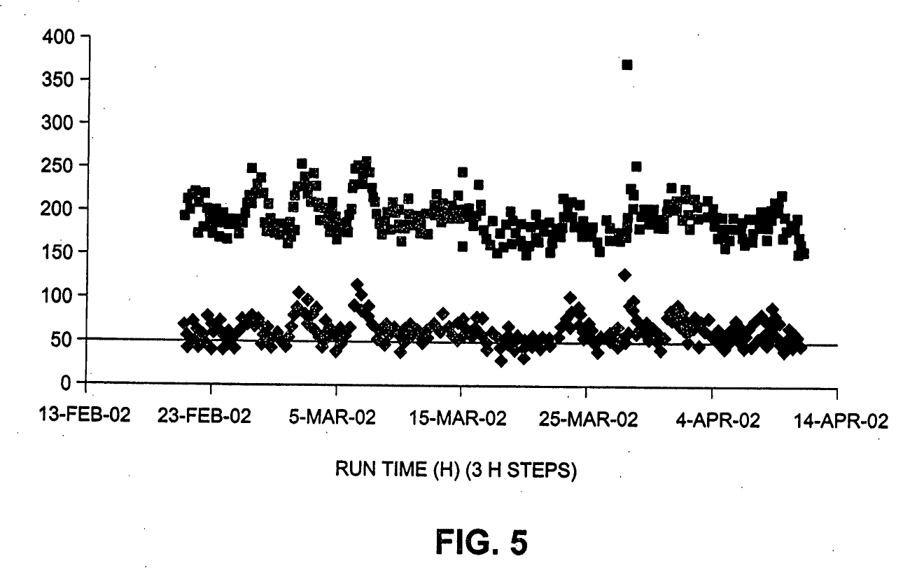

FIG. 5 shows a typical data output from a radon detector of the invention. Gross counts of ²¹⁸Po (6002 keV) in the lower distribution and ²¹⁴Po (7687 keV) in the upper distribution, shifted 100 counts for clarity of comparison. These counts are plotted against run time in 3 hour steps. The data presented are typical of the detector according to the invention. The sharp increase shown around Mar. 27, 2002 correlates with the sudden thaw followed by a freeze in early spring weather observed at the location of analysis. In the open mode, radioactive equilibrium was established in the same way. Spectra were recorded for a preset period of time and automatically saved to the data acquisition computer. The integrals of the counts under the peaks corresponding to ²¹⁸Po and ²¹⁴Po were plotted as a function of time automatically. The time variation of the counts at either of the peaks was calculated as a measure of the variation of the radon concentration in room air.

The ratio of the counts under the two peaks was found to be constant over prolonged periods of time but never equal to 1.0, and it was found to be location dependent. The dependency was almost entirely related to the aerosol content at the test location. Therefore, the sealed mode can be used to calibrate the system at any given location to arrive at the absolute value of the concentration of radon in room air. The time dependency of the concentration at any given location was reflected by the simultaneous increase of decrease in the counts under both of the peaks of the ²²²Rn daughters.

SABRE™ radon detectors may be deployed at surface and underground installations for unattended operation. They can be attached to the Internet as web-enabled devices with the results being presented on a secure remote web server. Changes in indoor concentration of radon in air at surface installations were observed which correlate with the freeze/thaw cycles of the outdoor ground during winter, and the fluctuations in weather conditions during other seasons. The SABRE™ radon detection system is capable of monitoring changes in radon concentrations with a minimum integration time of one hour in the concentration range from 0.01 pCi/L and greater.

Time dependent changes in the ratio of the radon daughter products ²¹⁸Po and ²¹⁴Po were observed at underground sites and indoor locations on the surface. These changes correlated with increased air-borne particle counts at the same locations, and suggest that varying aerosol loads will change the exposure levels in working level units.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A device for detection of radon or radon daughters in ambient air comprising:
a) an electrical field comprising two hemispherical walls facing each other, with a gap therebetween through which ambient air diffuses, said walls forming a sensitive volume; and
b) a positively-charged photodiode in communication with said sensitive volume for the detection of alpha emissions from radon or radon progeny electrically isolated within said electrical field.

2. The device of claim 1 wherein the hemispherical walls comprise food preparation bowls.

3. The device of claim 1 wherein said hemispherical walls comprise hemispherical steel round-bottomed deep fryers.

4. The device of claim 1 wherein said gap is from 1 to 6 mm between said two hemispherical walls.

5. The device of claim 4 wherein said gap is about 1.5 mm.

6. The device of claim 1 additionally comprising a light shielding means surrounds said gap to partially exclude light from the sensitive volume.

7. The device of claim 1 wherein the sensitive volume is from 1 L to 400 L

8. The device of claim 7 wherein the sensitive volume is selected from the group consisting of about 11 L, 60 L, and 208 L.

9. The device of claim 1 wherein said hemispherical walls comprise aluminum tubing supporting an aluminized polyester film on all sides.

10. The device of claim 9 wherein said tubing has a diameter of approximately 0.5 inch.

11. The device of claim 10 wherein said sensitive volume is up to about 1000 L.

12. The device of claim 1 wherein said photodiode is a positive-intrinsic-negative (PiN) diode.

13. The device of claim 12 wherein said PiN diode is operated in a reverse bias mode.

14. The device of claim 1 wherein said alpha emissions are emitted from daughters generated from the decay of radon (²²²Rn) or thoron (²²⁰Rn).

15. The device of claim 14 wherein said daughters are ²¹⁸Po, ²¹⁴Bi, or ²¹⁴Po emitting energetic alpha particle radiation at 6003 keV, 6020 keV, and 7687 keV respectively.

16. The device of claim 14 wherein said daughters are generated from decay of thoron and are ²¹⁶Po or ²¹²Po, emitting energetic alpha particle radiation at 6778 keV and 8785 keV, respectively.

17. A method for computing concentration of radon in ambient air comprising evaluating relative ratio of radon daughters ²¹⁸Po and ²¹⁴Po in the sensitive volume of a device according to claim 1.

18. A system for detection of radon or radon daughter concentrations in ambient air comprising:
a) the device of claim 1;
a) a battery box in communication with said positively charged photodiode;
b) signal conditioning means for receiving and manipulating a signal from said positively charged photodiode; and
d) a computer to receive a manipulated signal from the signal condition means to display a radon or radon daughter concentration.
